(19) United States
(12) Patent Application Publication
(10) Pub. No.: US 2007/0289883 A1
(43) Pub. Date: Dec. 20, 2007

(54) COLORANT PACKETS AND METHODS RELATING THERETO

(75) Inventors: Susan Carol, Minneapolis, MN (US); John C. Daugherty, Eden Prairie, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: PLANNA TECHNOLOGY, INC., Minneapolis, MN (US)

(21) Appl. No.: 11/850,352

(22) Filed: Sep. 5, 2007

Related U.S. Application Data
(63) Continuation of application No. 10/686,449, filed on Oct. 15, 2003, now abandoned.

(51) Int. Cl. B44D 3/12; A47F 7/28; B65B 3/04; B65B 7/02; B65D 33/04; B67D 5/40; G06Q 90/00

(52) U.S. Cl. 206/81; 206/769; 222/226; 434/98; 53/469; 53/473; 705/14

(57) ABSTRACT

A colorant sample comprising a flexible pouch with a portion of the colorant, paint, or stain therein, wherein the pouch may have an opaque area and a transparent window and may have removable label thereon, and the portion of colorant may be dispensed into the pouch from a reservoir that is agitated.

### RELATED APPLICATIONS

This application is a continuation of U.S. patent application Ser. No. 10/686,449 filed Oct. 15, 2003.

### FIELD

This invention relates to the field of colorants such as paints and stains and more specifically to samples of colorants and methods of manufacture and use of colorant samples.

### BACKGROUND

Selecting a shade of indoor or outdoor paint for walls, floors or other surfaces is often a difficult task. A shade of paint looks different under different conditions such as the lighting present, the surface to be painted, the size of the surface to be painted, and surrounding colors and objects. Consumers who desire an accurate sample often have to buy a can of paint and paint a small area. Many retail outlets offer thousands of different colors and consequently do not stock all the colors. Rather, the retail outlet often mixes the paint to order. The smallest size that can usually be mixed is a quart and the accuracy of the mixing process tends to decrease with the size of amount of paint being mixed. Ordering several quarts of paint to select a preferred color can be expensive and wasteful. Consumers therefore often choose to rely on a printed color chip that is a square inch or less in size. These color chips are not small pieces of material painted with the actual paint; they are merely cardstock printed with an ink equivalent of the color. The color chips, therefore, are not always accurate. Some companies have introduced mini-cans of paint, often holding only three or four ounces. These cans are expensive and difficult to use and because of the small size of the can, may vary considerably from the actual shade. At least one company provides a hand-filled paint sample in a clear plastic bag attached to and enclosed in a cardboard folder. There is a danger of prematurely rupturing the plastic bag when removing the paint sample from the cardboard folder. Many paint lines include over a thousand colors, which makes providing a sample size for each color difficult. Moreover, the paint mixing apparatus typically found at stores that sell paint is incapable of producing a small sample with any accuracy.

Selecting a stain presents similar difficulties. The smallest size can of stain covers a considerable area. Buying several cans to select the proper shade is wasteful and generates excess material that is difficult to dispose of and may present an environmental hazard. To help their customers select a stain, some retail outlets will apply several stains to a sample board for their customers. This is a time consuming and costly process for those retail outlets.

### SUMMARY

One embodiment pertains to a paint sample comprising of a small quantity of paint sufficient to paint at least a square foot in a pouch. The pouch may generally be made of a strong, flexible material and may have a clear window for viewing the paint. The pouch also may include an opaque portion for printing and a detachable label having indicia indicating the particular paint. The pouch may have directions printed thereon for opening the pouch across the top and applying the paint to a surface using a brush directly out of the pouch.

Another embodiment pertains to a process for producing the paint sample. The process ensures that the color of the portion of paint in the sample is close to the desired shade and produces uniform samples from a particular batch.

Another embodiment pertains to a first process for providing the consumer access to the paint samples. Often, a paint line has several thousand shades of paint. It is impractical to provide samples of each shade in a retail outlet. One embodiment, therefore provides selected shades of the paint line in a paint sample to provide the consumer with a representative idea of the colors available in the paint line. Another embodiment permits the consumer to select desired shades in the store or online and have the paint samples mailed directly from a warehouse to the consumer.

Another embodiment pertains to a stain sample having a pouch with a small quantity of stain inside. The pouch may have the stain or a reproduction of stained wood printed on the outside of the pouch or may have a transparent window for viewing the stain. The stain sample may also include a cloth for applying the stain. The cloth may be lint free and may be in the pouch with the stain applied to the cloth, or may be included separately from the stain.

Another embodiment pertains to a process for manufacturing the stain sample. The process ensures the stain included in the stain sample is an accurate sample, having the correct ratios of pigments and other materials.

The above summary of some embodiments is not intended to describe each disclosed embodiment or every implementation of the present invention. The figures and detailed description which follow more particularly exemplify these embodiments.

### DRAWINGS

The invention may be more completely understood in consideration of the following detailed description of various embodiments of the invention in connection with the accompanying drawings in which:

FIG. 1 is a plan view of the front of an example paint sample 10;

FIG. 2 is a partial plan view of the back of the example paint sample 10 of FIG. 1;

FIG. 3 is a plan view of the front of an example stain sample 100.

FIG. 4 is a partial plan view of the back of the example stain sample 100 of FIG. 3.

### DETAILED DESCRIPTION

The following detailed description should be read with reference to the drawings, in which like elements in different drawings are numbered identically. The drawings which are not necessarily to scale, depict selected embodiments and are not intended to limit the scope of the invention.

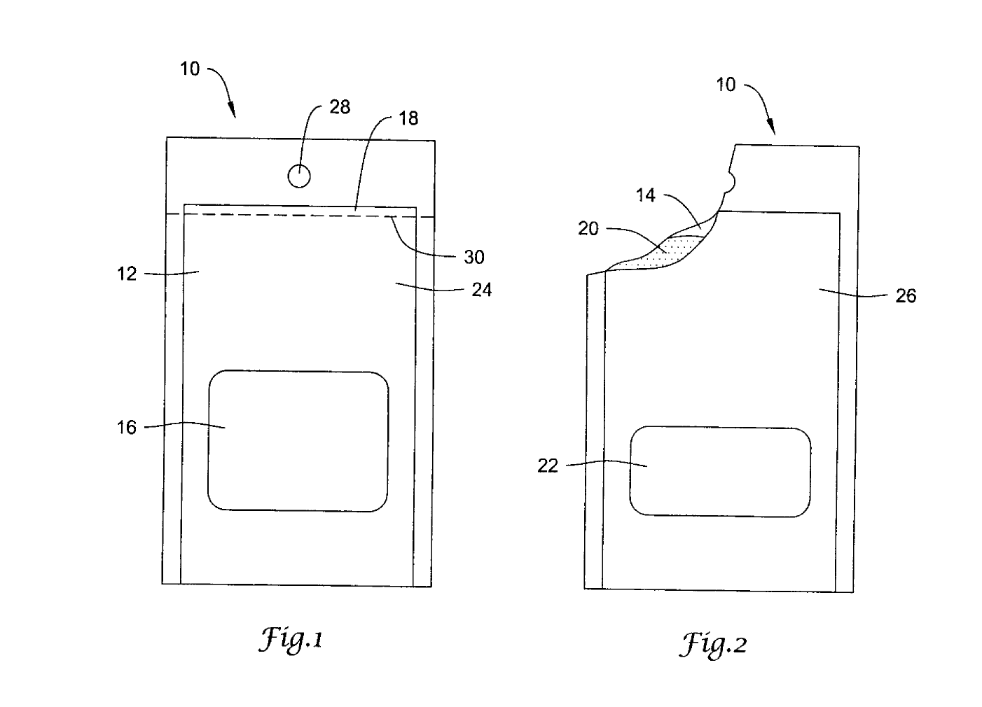

FIGS. 1 and 2 depict, respectively, a front plan view and a back partial plan view of an example paint sample 10. Paint sample 10 has a pouch 12 having a front panel 24 and a back panel 26 joined together. Pouch 12 has a cavity 14 and a transparent window 16 for viewing the contents of cavity 14. Window 16 is depicted in FIG. 1 as being on the front bottom of the pouch but may be anywhere on the pouch. Pouch 12 also has an opaque portion 18 for displaying text, graphics, and other indicia. Opaque portion 18 may be oblong or some other suitable shape. For example, pouch 12 may have an opaque portion 18 having a line 30 printed across the top and associated instructions for opening the pouch printed thereon. The instructions may, for example, direct a user to open the pouch by cutting across the line and then to apply the paint directly from the pouch using a brush or other applicator. A portion of paint 20 is disposed in cavity 14. Pouch 12 may be made from a flexible material such as a polymer film. This flexibility would, for example, permit the mixing of paint portion 20 by kneading while pouch 12 is sealed. Paint sample 10 may also include a label 22 that contains information regarding the particular paint portion 20. This information may include, for example, the name of the paint color and a barcode. Label 22 may be removable and may be in the form of a perforated tab, a peelable sticker, a clipable coupon or other suitable configuration. Pouch 12 may have a hole 28 punched into the edge seal to permit easy mounting into a display rack. Pouch 12 having an opaque portion 18 and a window 16 permits use of the same pouch 12 having the same material printed thereon to be used for different colors of paint because the paint color may be readily identified through the window. All indicia pertaining to a particular color may therefore be printed on label 22.

In an example use, paint sample 10 may first be kneaded to mix the paint, if desired. Window 16 permits viewing of paint portion 20 prior to opening to see whether paint portion 20 is mixed properly. Paint sample 12 may then be opened by cutting pouch 12 across the top. Paint portion 20 may be poured from pouch 12 into a suitable container, for example a disposable plate, if desired. Paint portion 20 may also be applied directly from pouch 12. If one cuts pouch 12 directly across the top, one creates an oblong opening which is advantageously roughly the same shape as typical paint brushes. Pouch 12 can therefore accommodate larger paint brushes than if it had a different cross section such as a rigid circular cross section of a typical paint can contain an equivalent amount of paint. Paint portion 20 is applied to the desired surface such as a sample board or a wall. Paint sample 10 may include directions indicating that the sample may be opened by cutting it across the top and that the paint may be applied by brush or applicator directly from the pouch. The paint may be a typical house paint such as a latex paint or an oil paint, or it may be another suitable paint.

Paint sample 10 may be manufactured by the following example process. A suitable pouch material is selected. Suitable pouch materials are compatible with paint, and are strong enough to resist puncturing or bursting. Criteria for paint compatibility include chemical compatibility and low transfer rate across the material of volatile compounds in the paint. The materials may also be transparent, receptive to printing, and flexible. An example of a suitable pouch material is a nylon film of suitable thickness to provide the desired strength, with a low density polyethylene layer on one side for ink receptivity and a heat activated sealant layer on the opposite side. Of course, other suitable materials may be used. Designs and indicia may be printed on the pouch material. A section of the pouch material may be cut to a suitable size to form the front and the back panels, and then folded. The side edges may then be sealed. If the material includes an adhesive layer, the sealing may be performed by activating the adhesive by heat or other suitable method. Alternatively, the side edges may be sealed by applying an adhesive and thereby affixing the edges together. Alternatively, the pouch material may come in tubular form, in which case the material is cut to length and the bottom edge sealed to form the cavity, or the pouch may be preformed through blow-molding, injection molding or other suitable technique. At this stage, the pouch has front and back panels joined on three sides forming a cavity with an opening at the top. A portion of paint is dispensed into the cavity and the top is sealed up using the methods described for sealing the sides. The portion of paint is typically less than four liquid ounces and may be between 1 and 3 liquid ounces. Of course, other quantities of paint are contemplated. If the pouch used for making the paint sample has a clear window as described above with reference to FIGS. 1 and 2, the clear window may be used in a non-destructive quality control test such as, for example, a visual inspection to ensure uniformity among the paint samples in a particular batch or to ensure that the samples in a particular batch are the desired color.

The portion of paint is dispensed into the cavity of the pouch from a batch of paint. During the dispensing process, the batch of paint is mixed or agitated to prevent solids such as titanium dioxide and pigments from settling out of the paint. This continuous agitation improves the uniformity of the paint samples created. One example apparatus for dispensing the paint includes a paint reservoir, a pump, and an electrically actuated valve. The paint is continuously pumped from the reservoir and back into the reservoir through a hose during the dispensing process. This serves to effectively agitate the paint in the reservoir, keeping the pigments in suspension. The rate of the fluid being pumped in this manner is greater than the rate of the paint being dispensed into pouches. There is a valve attached to the hose for dispensing the paint into the pouches. The excess paint pumped is returned to the reservoir. Any suitable pump may be used. In one embodiment, the pump used is an appropriately sized peristaltic pump. Other suitable pumps may include a gear pump or an impeller pump. It may be desirable to use a valve that is able to dispense paint directly into the bottom of the pouch cavity without getting paint on the upper sealing edges of the pouch. This may promote a more effective top seal. Another example apparatus may be a raised paint reservoir having a mixing paddle therein. The paint may be gravity fed into the pouches.

One method for providing the consumer with access to paint samples is to put select colors of paint samples into the store. The paint samples may be selected to represent the full range of hues, shades, and tones available in a particular line. A line is intended to mean the largest collection of paint colors sold or marketed under a particular name designed to associate those paint colors together. A line is not necessarily intended to be so broad as all the paint colors sold by a manufacturer, but may be so broad if that is how that manufacturer sells and markets its paint colors. Moreover, there may be narrower groupings of paint colors within a particular line. In one example sampling method, the thousands of paint colors in a line of paints may be organized by hue, and then by shade and tone. “Hue” is herein intended to mean the pure color, “tone” is intended to mean the level or amount of pure color present, and “shade” is intended to mean the level of white or black present. The paint packets can then be selected to show the range of hues available in the paint line and then the range of tones and shades available. The selection may also include the most popular 0.1%-1%, 0.1%-3%, 0.1%-5%, 0.1%-10%, 0.1%-20%, or 0.1%-30% of colors, or other desired amount. Thus, an example display rack in a store for a paint line offering 1000 different colors may include 20 or so of the most popular colors and 100 or so showcasing the range of hues, shades and tones available. The paint samples may also vary among gloss, semi-gloss, and matte. In another example, the selection may include the most popular shades for walls and the most popular shades for trim. Another example selection includes 5%, 10% or another appropriate amount of the hues, each hue being represented by 1-3, 1-5, 1-8 or another desired number of packets having that hue and the same variations of shade and tone as the other hues. In another example selection, the paint samples are selected based on one or more themes, a theme being a collection of colors that may be associated with the topic of that theme. In another example, the selection consists of 0.1%-1%, 0.1%-3%, 0.1%-5%, 0.1%-10%, or 0.1%-20% of the available hues, 0.1%-1%, 0.1%-3%, 0.1%-5%, 0.1%-10%, or 0.1%-20% of the available tones, and/or 0.1%-1%, 0.1%-3%, 0.1%-5%, 0.1%-10%, or 0.1%-20% of the available shades, or any combination thereof.

These selections from a larger line of paint are intended to make a representative sample of the colors available to the consumer. This may be done by placing them on a display rack in a retail store. Alternatively, a kit may be made up for an interior decorator or contractor. Such a kit would include the selection of colors organized inside a carrying case.

Alternatively or in conjunction with a store display or contractor kit, the full line or substantially the full line of paints could be warehoused in a central location, ready for shipment to the consumer. For example, 1000 different colors of paint samples could be available for shipment consistent with the example above. In one method of distribution, a consumer could select desired sample colors at a paint store, and the paint store could order the paint samples to be delivered to the store for pickup or directly to the consumer. This method could supplement or replace the selection and racking method described above. A store would avoid tying up space and capital in paint samples while still able to provide a sampling service to its customers. In another example method, paint samples could be offered to consumers through the internet. A customer may be able to browse the full line of paints, select desired colors, and order samples to be delivered. A paint manufacturer may be able to provide accurate samples to its customers over the web and then direct those customers to a retail outlet for larger quantities of the color.

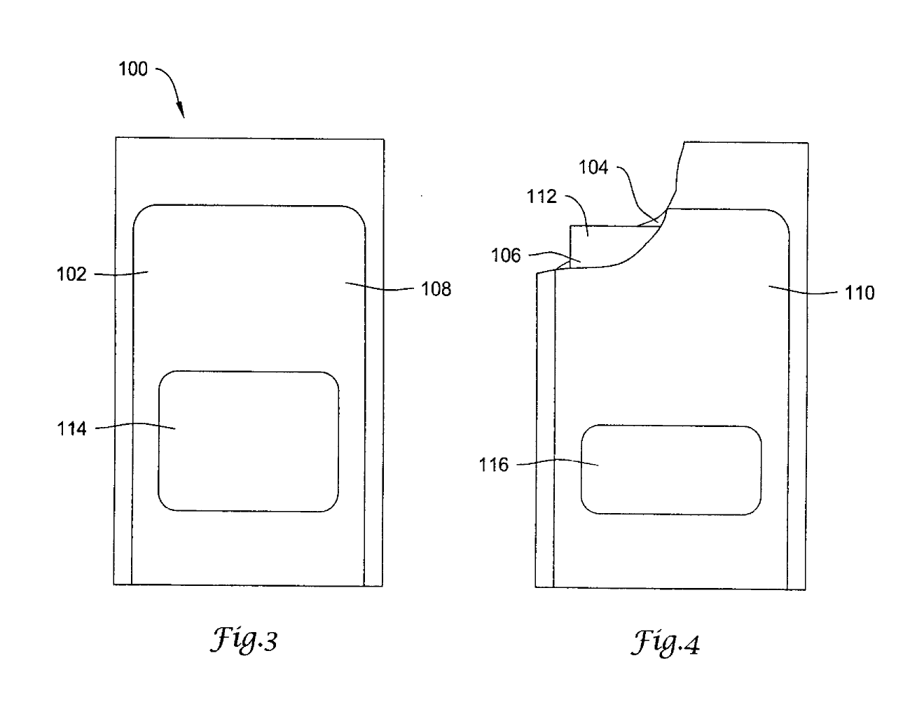

FIGS. 3 and 4 depict, respectively, plan and partial plan views of a stain sample 100. Stain sample 100 includes a pouch 102 having an interior cavity 104 with a portion of stain 106 therein. Pouch 102 may have a front panel 108 joined at the edges to a back panel 110 to form cavity 104. Stain sample 100 may include a cloth 112. Cloth 112 may be in cavity 104 dampened by stain portion 106. Cloth 112 may be a lint free cloth such as a sonic bonded polypropylene non-woven cloth. The pouch may be formed of a flexible material that is chemically resistant to the stain. One suitable pouch material is a film having a foil layer between two or more polymer layers, such as a film offered by MACtac® under the tradename Liquiflex®. If desired, pouch 102 may have a transparent window 114 for viewing the stain and the cloth or may have an illustration of wood stained with the particular stain printed on the outer surface. Pouch 102 may also have a removable label 116 having indicia indicating the particular stain in the pouch.

Stain sample 100 may be created according the following example method of manufacture. A piece is cut to size from a roil of suitable film. The piece is folded in half and the side edges are sealed with an adhesive or with a heat seal, forming a pouch cavity with a top opening. Of course, other suitable pouch forming techniques, such as but not limited to those discussed above with respect to FIGS. 1 and 2, are contemplated. A piece of non-woven cloth is cut from a roll and inserted into the pouch cavity. A portion of stain is then dispensed into the cavity and the pouch is sealed. The portion of stain may be less than 10 ml and may be between 4 and 6 ml. The portion of stain is dispensed from a batch of stain in a reservoir that is kept agitated during the dispensing process. The agitation may be carried out by pumping stain from the reservoir at a rate greater than the rate the stain is being dispensed into pouches. The excess stain is returned to the reservoir. Of course, the agitation may be carried out by other means as well. For example, a rotating paddle or mixing blade may be put in the reservoir. The pump used in this process is selected based on the type of stain being used in the stain sample. The viscosity of different types of stain varies widely. For example, many stains suitable for indoor use have a lower viscosity than many stains suitable for outdoor use. The reservoir may be raised above the level of the pump to aid the action of the pump.

Numerous advantages of the invention covered by this document have been set forth in the foregoing description. It will be understood, however, that this disclosure is, in many respects, only illustrative. Changes may be made in details, particularly in matters of shape, size, and arrangement of parts or order of steps without exceeding the scope of the invention. The invention's scope is, of course, defined in the language in which the appended claims are expressed.

What is claimed is:

1. An apparatus comprising:
a container having a front panel having a edge and a back panel having a edge, the edges connected to form a cavity for retaining a liquid, the container having a transparent portion and an opaque portion; and
an amount of paint having a color disposed in the cavity.

2. The apparatus of claim 1, wherein the container is flexible

3. The apparatus of claim 1, wherein the container is a pouch.

4. The apparatus of claim 1, wherein the transparent portion comprises a first part of the front panel and wherein the opaque portion includes a second part of the front panel.

5. The apparatus of claim 4, wherein the opaque portion comprises a oblong area for displaying text or graphics.

6. The apparatus of claim 1, wherein the container comprises a line for delineating a recommended opening.

7. The apparatus of claim 1, wherein the container comprises text indicating an identifying characteristic of the paint.

8. The apparatus of claim 7, wherein the container further comprises a removable label and wherein the text indicating an identifying characteristic is disposed of the label.

9. The apparatus of claim 8, wherein the removable label is reattachable.

10. The apparatus of claim 9, wherein the removable label comprises an adhesive for use in reattachment.

11. The apparatus of claim 1, wherein the amount of paint is between 1 and 3 ounces.

12. The apparatus of claim 1, wherein the container has an oblong lateral cross-sectional shape.

13. A method of filling a paint packet comprising the steps of:
providing a packet having an open top end;
providing a source of paint;
dispensing a portion of paint into the packet; and
mixing the source of paint while dispensing.

14. The method of claim 13,
wherein the step of mixing the source comprises the step of providing a stream of paint flowing from the source and back to the source; and
wherein the step of dispensing a portion comprises the step of dispensing the portion of paint from the stream into the open top end of the packet.

15. The method of claim 13, wherein the step of dispensing a portion includes the steps of
starting a flow of paint; and
stopping the flow of paint.

16. An apparatus for dispensing paint into a packet, comprising:
a paint reservoir;
an agitator capable of continuously agitating paint in the paint reservoir; and
a dispensing valve to dispense a portion of paint from the paint reservoir during agitation.

17. The apparatus of claim 16, wherein the mixer comprises a first conduit for removing paint from the paint reservoir and a second conduit for returning paint to the reservoir.

18. The apparatus of claim 17, wherein the mixer further comprises a pump.

19. The apparatus of claim 18, wherein the pump is a peristaltic pump.

20. A method of displaying a selection of paint, comprising the steps of:
providing a line having a number of different paint colors, each paint color having a hue, a shade, a tone, and a popularity;
selecting a subset of paint colors from the line, the subset being less than the whole line;
providing a plurality of packets, each packet containing a portion of paint having a color, the plurality containing the subset.

21. The method of claim 20, wherein the subset comprises 3% of the available hues in the line.

22. The method of claim 20, wherein the subset comprises 3% of the available tones in the line.

23. The method of claim 20, wherein the subset comprises 3% of the available shades in the line.

24. The method of claim 20, wherein the subset comprises 3% of the most popular 4% of the paint colors in the line.

25. An apparatus for containing a liquid colorant, comprising
a container having a sealed storage cavity, an oblong cross-sectional shape, an oblong opaque portion, and a transparent window for viewing the contents of the cavity; and
a liquid colorant disposed in the cavity.

26. The apparatus of claim 25, wherein the liquid colorant is a paint.

27. The apparatus of claim 25, wherein the liquid colorant is a stain.

28. A apparatus, comprising
a sealed container;
a cloth disposed in the sealed container; and
a stain disposed in the sealed container.

29. The apparatus of claim 28, wherein the sealed container has an oblong cross-sectional shape.

30. The apparatus of claim 28, wherein the sealed container is a flexible pouch.

31. The apparatus of claim 28, wherein the cloth is a lint-free cloth.

32. A method of creating a sample of a liquid colorant, comprising the steps of:
providing a sample container;
providing a source containing a batch of a liquid colorant;
agitating the batch of liquid colorant;
dispensing a portion of the batch into the container while agitating the batch; and
sealing the container.

33. The method of claim 32, comprising the step of inserting an absorbable cloth into the container.

34. A method for distributing a sample to a consumer, comprising the steps of:
providing a line of paints having a plurality of different colors;
providing a plurality of web pages displaying an indicia for each of the plurality of different colors;
providing a paint sample for substantially each of the plurality of different colors; and
providing an system for the consumer to order and receive a paint sample for substantially any of the plurality of different colors.

35. The method of claim 34, further comprising the steps of:
providing a retail outlet;
selecting a subset of the line of paints have a plurality of different colors, the subset being less than the whole line of paints;
providing paint samples for each of the plurality of colors in the subset in the retail outlet.

36. The method of claim 34, further comprising the step of providing access to plurality of web pages to a consumer in the retail outlet.

37. The method of claim 34, wherein the plurality of different colors exceeds 500.

38. The method of claim 34, wherein the paint sample is a flexible pouch having a cavity with a portion of paint therein, the flexible pouch having a transparent window and an opaque oblong thereon.
